(19) United States
(12) Patent Application Publication
(10) Pub. No.: US 2009/0293988 A1
(43) Pub. Date: Dec. 3, 2009

(54) System for Charging and Purging a Compressed Gas Cylinder

(75) Inventors: David W. Pang, Beijing (CN); ZhiQiang Shi, He Bei (CN); Mauricia Guerra, Rio Grande De Sul (BR)

Correspondence Address: James E. Bradley;BRACEWELL & GIULIANI LLP, P.O. Box 61389, Houston, TX, 77208-1389, US

(73) Assignee: NEOgas Inc., Spring, TX (US)

(21) Appl. No.: 12/435,078

(22) Filed: May 4, 2009

Related U.S. Application Data
(60) Provisional application No. 61/050,033, filed on May 2, 2008.

(51) Int. Cl. B67C 9/00; B67C 3/06

(52) U.S. Cl. 141/59; 141/51; 141/52; 141/65

(57) ABSTRACT

A fixed and/or stationary modular unit consists of a hydraulic fluid tank, a pressurization pump, and a compressed gas transportation system consisting of a cylinder or set of cylinders. Each cylinder has two ends, a charging end and a dispensing end, with actuated valves positioned at each end. A pair of valves are located at each charging end of each cylinder, with one valve connected to an incoming hydraulic fluid line and the other valve connected to a hydraulic fluid return line. A valve is connected at the dispensing end of each cylinder. Adapters at each end of the cylinder have curved J-tubes that extend into the cylinder. The J-tube on the charging end curves downward and the J-tube on the dispensing end curves upward. The cylinder or sets of cylinders are inclined to a desired level for the dispensing process.

This application claims priority to provisional application 61/050,033, filed May 2, 2008.

### FIELD OF THE INVENTION

This invention is a hydraulic pressurization station and/or equipment, also known as an “HPU” (Hydraulic Pressurization Unit), which can be connected to an over-the-road semi trailer (OST) of the type known as a horizontal cylinder (or tubular-cylinder) trailer. This invention also applies to a compressed gas pressurization and control system of an over-the-road semi trailer for the compressed gas dispensing line, maintaining a constant pressure throughout the entire operation.

### BACKGROUND OF THE INVENTION

Compressed natural gas (CNG) is any natural gas that has been processed and treated for transportation, in bottles or cylinders, at ambient temperature and at a pressure approaching the minimum compressibility factor.

Natural gas is colorless, odorless, and lighter than air, and it easily dissipates into the atmosphere when it leaks. It bums with a flame that is almost invisible, and it has to be raised to a temperature above 620° C. in order to ignite. By way of comparison, it should be noted that alcohol ignites at 200° C. and gasoline at 300° C. For safety reasons, natural gas is odorized with sulfur for marketing purposes.

Natural gas is an alternative to oil and therefore, it has great strategic importance, since it is a fossil fuel found in porous subsurface rock. It usually has low levels of pollutants, similar to nitrogen, carbon dioxide, water and sulfur compounds that remain in a gaseous state at atmospheric pressure and ambient temperature. Compressed natural gas is stored at a pressure of 220 bars or 3190 psi and is transported in trailers of varying volumetric capacity, depending on legislation and customer/project requirements.

The principal advantage of using natural gas is the preservation of the environment. In addition to economic benefits, it is a non-polluting fuel and it burns cleanly, so its combustion products that are released into the atmosphere do not need to be treated.

The great need to transport and store natural gas has contributed to increasing gas research around the world. Traditionally, only a handful of methods of transporting and storing large quantities of gas have turned out to be feasible. The main problem in storing and transporting gas is the fact that it remains a gas far below ambient temperature and that a small quantity of gas occupies a large amount of space. The solution is to reduce the space gas occupies. Initially, the condensation of gas to a liquid was the mainly recommended logical solution. A typical natural gas (which is about 90% CH4) can be reduced to 1/600 of its gaseous volume when it is compressed into a liquid. Technically speaking, gaseous hydrocarbons in the liquid state are known as liquefied natural gas, which is more commonly known as LNG.

As indicated by the term, LNG involves liquefying natural gas and normally includes transporting and storing natural gas in a liquid state. Although liquefication would seem to be a solution as far as storage and transportation problems are concerned, there are certain disadvantages. First, in order to liquefy natural gas, it must be cooled to approximately −162° C. at atmospheric pressure before it liquefies. Second, LNG tends to warm up over long storage or holding periods, thus it does not remain at low temperature, which is required in order for it to remain in a liquid state. Cryogenic methods have been used to keep LNG well within the required temperature range while being transported, and the carrier system used to transport LNG must be fully cryogenic. Third, LNG must be regassified by distillation before it can be used, The cryogenic process requires a high initial cost to load and unload LNG. The container system and storage vessels require rare metals to keep the temperature at 160° C., so it cannot be justified as an economic alternative.

In order to solve the technical problems of ambient conditions of storage and transportation of LNG, as well as its temperature and high costs, a method of transporting compressed natural gas was developed. Natural gas is compressed or pressurized at high pressures. This is what is commonly called compressed natural gas or CNG.

Various methods have been proposed for storing and transporting compressed gases, such as natural gas, in pressurized vessels for overland transportation. The gas is typically stored and transported at high pressure and low temperature to maximize the amount of gas contained in each gas storage system. For example, compressed gas must be in a dense single-fluid state characterized as a very dense gas with no liquid.

CNG is typically transported over land in tanker trucks or tank wagons. Tankers have storage containers such as pressurized metal vessels. These storage vessels have high burst strengths and withstand the ambient temperature at which CNG is stored.

Before compressed natural gas is transported, the desired operation state is obtained first, normally by compressing the gas to a high temperature and then cooling it to a low temperature. After the compressing and cooling process, CNG is loaded into the holding vessels of the storage system. The CNG is then shipped to its destination.

Upon arrival at destination, the CNG is unloaded, typically at a terminal with a number of high-pressure storage vessels or a feedline into a high-pressure turbine. If the terminal is at a pressure of 69 bar or 1000 psi for example, and the storage vessels are at 138 bar or 2000 psi, then valve must be opened and the gas must be expanded at the terminal until the pressure in the vessels falls to a final pressure between 69 bar or 1000 psi and 138 bar or 2000 psi.

With conventional procedures, the CNG that has been shipped remains in the storage vessels (residual gas), which is then compressed in the terminal storage vessels by means of compressors. These compressors are expensive and increase the capital cost of the unloading process. Further, the temperature of the residual gas is raised by the heating effect of compression. The high temperature increases the required storage capacity, unless the temperature is lowered or excess gas is removed, thereby increasing onshore costs for transporting CNG. There would also be high energy consumption.

A new technique in necessary to reduce costs and the complexity of unloading CNG. The following technique may solve one or more of these problems. The present technique exceeds the deficiencies described by providing hydraulic pressurization equipment that is capable of servicing the motor vehicles efficiently while maintaining the same pressure at all times.

### SUMMARY OF THE INVENTION

A fixed and/or stationary modular unit consists of a hydraulic fluid tank, a pressurization pump, and a compressed gas transportation system consisting of a cylinder or set of cylinders. Each cylinder has two ends, a charging end and a dispensing end, with actuated valves positioned at each end. A pair of valves are located at each charging end of each cylinder, with one valve connected to an incoming hydraulic fluid line and the other valve connected to a hydraulic fluid return line. A valve is connected at the dispensing end of each cylinder. Adapters at each end of the cylinder have curved J-tubes that extend into the cylinder The J-tube on the charging end curves downward and the J-tube on the dispensing end curves upward. The cylinder or sets of cylinders are inclined to a desired level for the dispensing process.

Gas is dispensed from the dispensing end of the cylinder by opening the valve at the dispensing end. The valve connected to the incoming hydraulic fluid line is opened and hydraulic fluid is pumped from the tank and into the cylinder to maintain a constant pressure within the cylinder. When the cylinder is exhausted, the valve at the dispensing end of the cylinder is closed. The valve connected to the incoming hydraulic fluid is also closed, and the valve connected to the hydraulic fluid return line is opened. Remaining gas in the cylinder expands and discharges the hydraulic fluid from the cylinder and into the return line where it travels back into the hydraulic fluid tank.

### BRIEF DESCRIPTION OF THE DRAWINGS

FIG. 1(a) is a schematic of the hydraulic pressurization equipment (HPU) portion of the compressed gas filling system as comprised by the present technique;.

FIG. 1(b) is a detailed schematic of the over-the-road compressed gas semi trailer portion of the compressed gas filling system as comprised by the present technique;

FIG. 2 is a side view of a horizontal gas cylinder in its original orientation;

FIG. 3 is a side view of a horizontal gas cylinder inclined to a desired angle;

FIG. 4 is an end view of cylinders being supported by a cradle device connected to a hydraulic lift;

FIG. 5 is an assembled cylinder, showing the adapters illustrated in FIGS. 6 and 7;

FIG. 6 is a sectional view of the internal charging/discharging port at the bottom end of a horizontal gas cylinder;

FIG. 7 is a sectional view of the internal gas-dispensing port at the upper end of a horizontal gas cylinder;

FIG. 8 is a sectional view of a tilted gas cylinder with some hydraulic oil in the cylinder;

FIG. 9 is a sectional view of a nearly depleted tilted gas cylinder with a large amount of hydraulic oil in the cylinder;

FIG. 10 is a flow chart of the gas cylinder dispensing cycle.

### DETAILED DESCRIPTION OF THE INVENTION

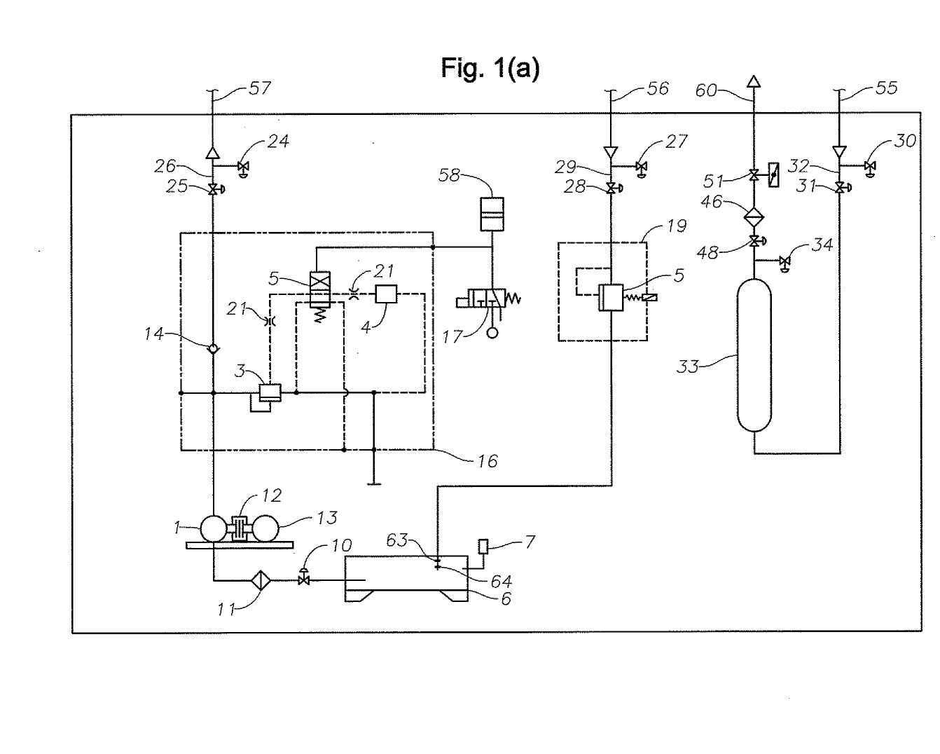

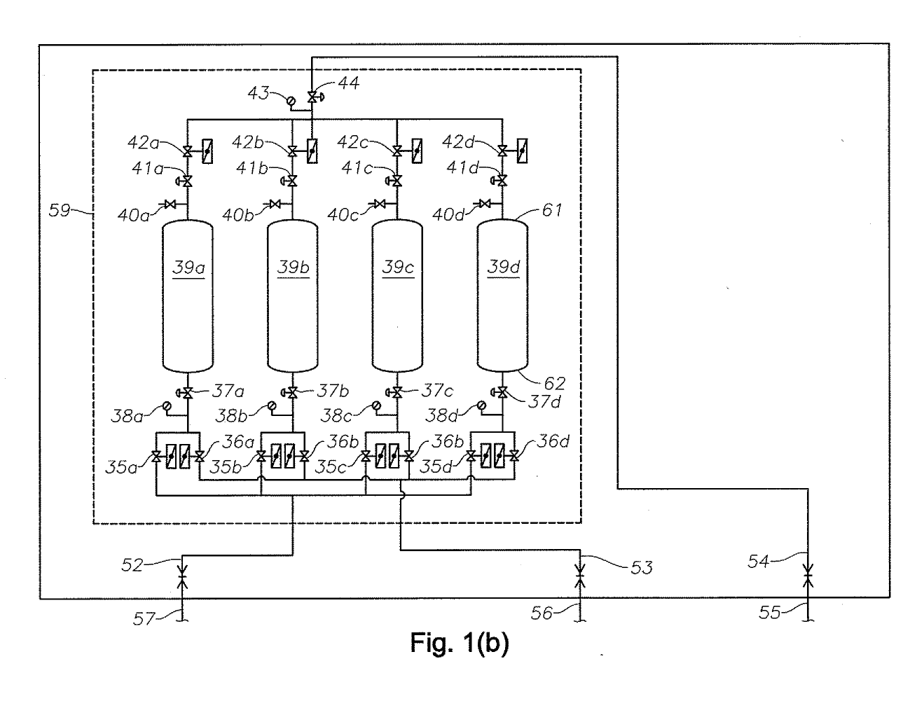

Referring to FIG. 1(a), the gas dispensing system consists of a hydraulic pressurization unit (HPU, which is connected to an over-the-road compressed gas semi trailer (FIG. 1b)). In an alternate embodiment, the HPU can be mounted on and a part of the over-the-road trailer itself. The over-the-road semi trailer may carry compressed natural gas, hydrogen, or other compressed gas cylinders.

The HPU consists of a hydraulic fluid tank 6, a motor 13, a flexible coupling 12 used to join rotating shafts, a suction and pressurization pump 1, an outgoing manifold block 16, a return manifold block 19, a pressure-control sensor 58, an electricelectronic control panel (not visible), and programmable logic controller (PLC) software. The HPU also consists of control valves 3, 4, 5, 17, manual shutoff valves 10, 25, 28, 31, 48, and particle filters 11, 46. The HPU also consists of manual release valves 24, 27, 30, 34. The outgoing manifold block 16 consists of valves 4, 5, 17, pressure sensor 58, excess-flow valve 3, a check valve 14, and restrictors 21. The return manifold block 19 consists of solenoid shutoff valve 5. Mounted to the oil reservoir tank 6 are photoelectric control sensors 63, 64, oil level switches 7, and a reservoir tank pressure switch (not visible). The HPU is used to charge compressed natural gas (CNG), hydrogen, or other compressed gas cylinders to a specific pressure. The HPU regulates the cylinder pressure by pumping hydraulic oil into the cylinders in order to maintain a specific pressure. The outgoing manifold block 16 controls the flow of hydraulic oil from the HPU to the compressed gas semi trailer. The return manifold block 19 controls the flow of hydraulic oil from the compressed gas semi trailer back to the HPU.

Referring to FIG. 1(b), the HPU (FIG. 1(a)) is connected to an over-the-road compressed gas semi trailer comprised of gas cylinder module 59, of which each module may consist of a single cylinder or grouped sets of horizontal (tubular) cylinders. For example, in this embodiment, module 59 is comprised of cylinders 39a-d. Each cylinder has a charging end 62 and a dispensing end 61, whereby a set of valves consisting of the following: safety devices 40a-d, manual shutoff valves 41a-d, 44, a pressure gauge 43, and actuated shutoff valves 42a-d, are connected at the dispensing end 61. The downstream connection from shutoff valve 44 is connected to a compressed gas loading/unloading line 54. A set of valves consisting of: pressure gauges 38a-d, manual shutoff valves 37a-d, and actuated shutoff valves 35a-d, 36a-d, are connected at the charging end 62.

The upstream connections from actuated shutoff valves 35a-d are connected to an incoming line 52, which has a quick connect/disconnect coupling mechanism positioned at its end. The downstream connections from actuated shutoff valves 36a-d are connected to oil return line 53, which has a quick connect/disconnect coupling mechanism positioned at its end. The upstream connections from the actuated shutoff valves 35a-d are connected parallel to one another. The downstream connections from actuated shutoff valves 42a-d are connected parallel to one another. The downstream connections from actuated shutoff valves 35a-d are connected with the charging end 62 of each of the cylinders 39a-d in series. The downstream connections from actuated shutoff valves 36a-d are connected parallel to one another. The upstream connections from actuated shutoff valves 42a-d are connected with the dispensing end 61 of each of the cylinders 39a-d in series.

Each module on the over-the-road compressed gas semi trailer is connected similarly. The cylinders on the over-the-road semi trailer are charged with compressed gas at another location. Subsequent to charging with compressed gas, the over-the-road semi trailer is transported to a gas filling station where an HPU is installed. In an alternate embodiment, the HPU can be mounted on the over-the-road trailer. The over-the-road compressed gas semi trailer is connected to the HPU with three hoses: an outgoing oil line 57, an oil return line 56, and a compressed gas line 55.

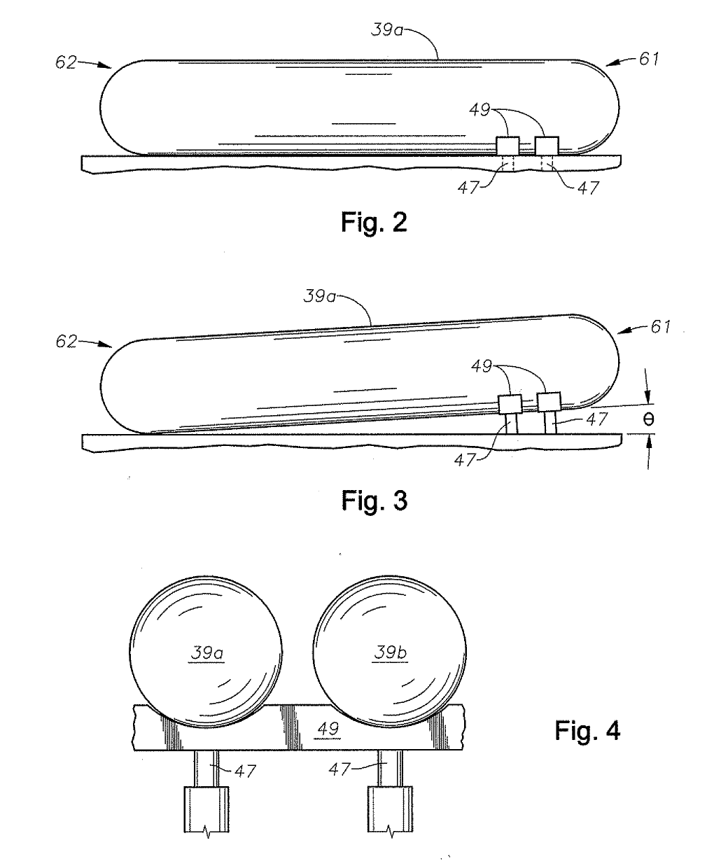

Referring to FIGS. 2, 3, and 4, once the cylinder module is connected to the HPU, the cylinder module is inclined using a hydraulic jack 47 with one end of the jack attached to the over-the-road semi trailer and the other end attached to cradle supports 49 that span the contours of the bottom of the cylinder module. The cylinders 39a-d contained in cylinder module 59 are inclined to a specified angle θ with the charging end 62 forming the vertex point and the dispensing end 61 raised to form the proper angle θ.

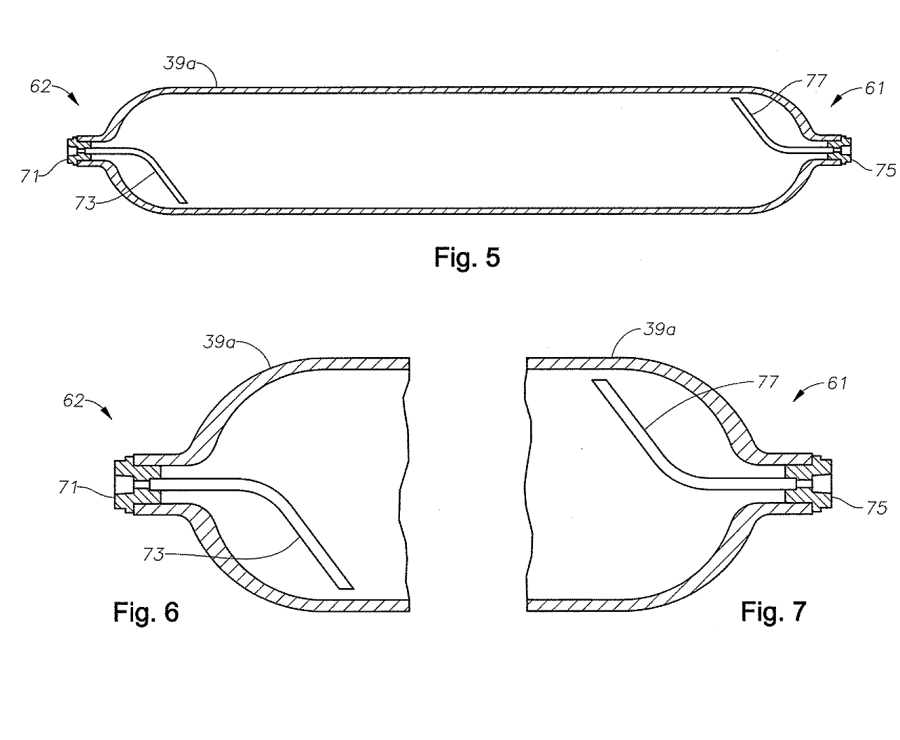

Referring to FIGS. 5, 6, and 7, each cylinder has a special curved adapter 71 at the charging/discharging end 62 (FIG. 6) and a special curved adapter 75 at the dispensing end 61 (FIG. 7). FIG. 6 illustrates the internal details of the gas charging area, which is at the bottom portion of the charging/discharging end 62 of the tubular type cylinder 39a. Adapter 71 consists of a curved tube 73 whose radius is dependent on the radius of curvature of the charging/discharging end 62 of the cylinder 39a. The adapter tube 73 curves downward toward the bottom surface of the charging/discharging end 62 of the cylinder 39a. The purpose of adapter 71 is to feed oil into the cylinder in a homogeneous form and to prevent blasts of oil into the cylinder. Additionally, when the oil is being discharged from the tank, adapter 71 helps prevents gas from entering the line discharging oil. This is due to the fact that the hydraulic fluid is more dense than the compressed gas within the cylinder, and as a result, a natural partition is created within the cylinder with a compressed gas layer formed atop a hydraulic fluid layer as hydraulic fluid enters the cylinder.

FIG. 7 illustrates the internal detail of the gas dispensing area, which is at the upper portion of the dispensing end 61 of the tubular type cylinder 39a. Adapter 75 consists of a curved tube 77 whose radius is dependent on the radius of curvature of the dispensing end 61 of the cylinder 39a. The adapter tube 77 curves upward toward the top surface of the dispensing end 61 of the cylinder 39a. The purpose of adapter 75 is to increase gas dispensing efficiency and to prevent hydraulic fluid from entering the line receiving gas. Additionally, the curved adapter tube 77, combined with the tilt of the tank, ensures that a maximum quantity of gas is dispensed before hydraulic oil reaches the tube 77. As previously noted, this is due to the fact that the hydraulic fluid is more dense than the compressed gas within the cylinder.

Referring back to FIGS. 1(a) and 1(b), in order to dispense the compressed gas from the cylinder module, the start button on the control panel (not visible) is pushed and the HPU begins unloading gas from compressed gas cylinder 39a of module 59 on the over-the-road semi trailer. The electronic control panel (not visible) sends a signal to actuated shutoff valve 42a on the dispensing end 61 of module 59, and actuated shutoff valve 51 on the HPU, opening valves 42a, and 51, allowing the gas in cylinder 39a of module 59 to be dispensed. The gas dispensed from module 59 flows through gas line 54, which has a quick connect/disconnect coupling mechanism positioned at its end, and hose 55 until it reaches gas line 32 of the HPU. When the gas reaches line 32 of the HPU, the gas flows through shutoff valve 31 and a hydraulic fluid separator 33, and then through a shutoff valve 48, particle filter 46, an actuated shutoff valve 51, and finally through the dispensing gas line 60. As the gas is dispensed from module 59, the pressure sensor 58 senses the gas pressure drop in cylinder 39a, and when the pressure reaches a selected level, such as 200 bar or less, the sensor 58 sends an electrical signal to the control panel (not visible), which then sends a signal that simultaneously actuates motor pump 13 and opens actuated shutoff valve 35a on the charging end 62 of module 59.

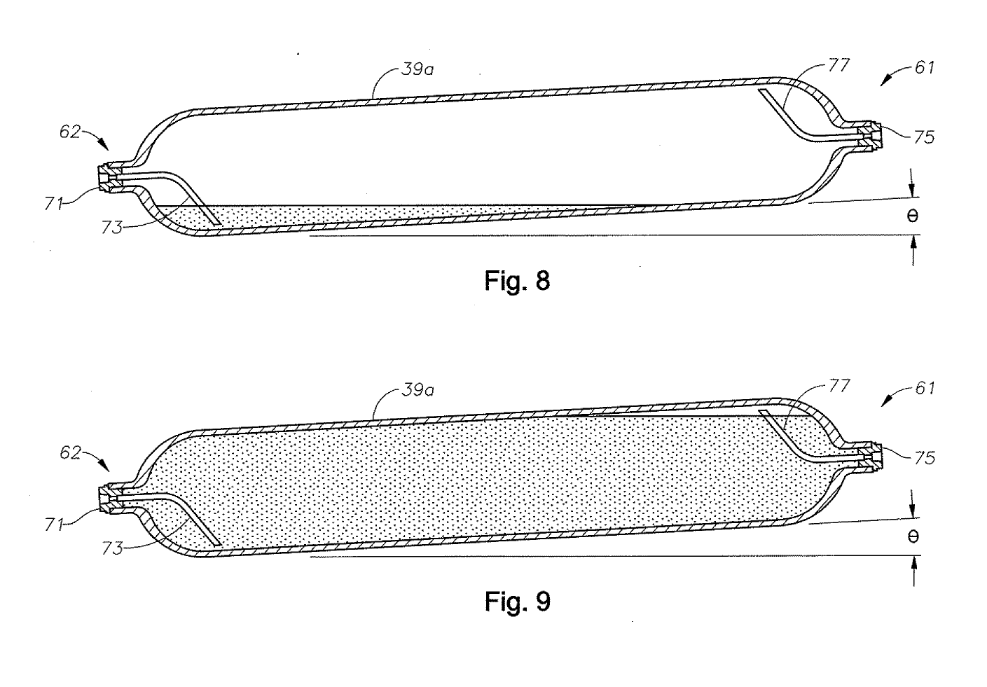

As motor 13 runs, pump 1 suctions the hydraulic fluid from tank 6, forcing it through manual shutoff valve 10 and particle filter 11. Pump 1 then forces the hydraulic fluid through the outgoing block 16, which regulates the fluid pressure at a selected range, such as 200-220 bar by means of flow valve 3, control valve 5, pressure sensor 58, and PLC control software (not visible). The hydraulic fluid is forced through outgoing block 16, through outgoing line 26 and outgoing line 57 to incoming oil line 52 of the over-the-road semi trailer. Control valve 3 also acts as an independent safety pressure relief valve, limiting system pressure to 240 bar in case of pressure sensor 58, PLC (not visible), or other system component malfunction. The hydraulic fluid flows through actuated shutoff valve 35a and into cylinder 39a of module 59, forcing the gas from cylinder 39a out the dispensing end 61 of the module (FIG. 8). Once the pressure sensor 58 senses the gas pressure has reached a selected pressure, such as 220 bar, an electronic signal from the control panel (not visible) actuates control valve 17, which allows the oil to flow back to the tank 6 through excess-flow valve 3. After a short time delay, motor 13 is switched off. During this time, gas is being dispensed through dispensing line 60 and into a vehicle.

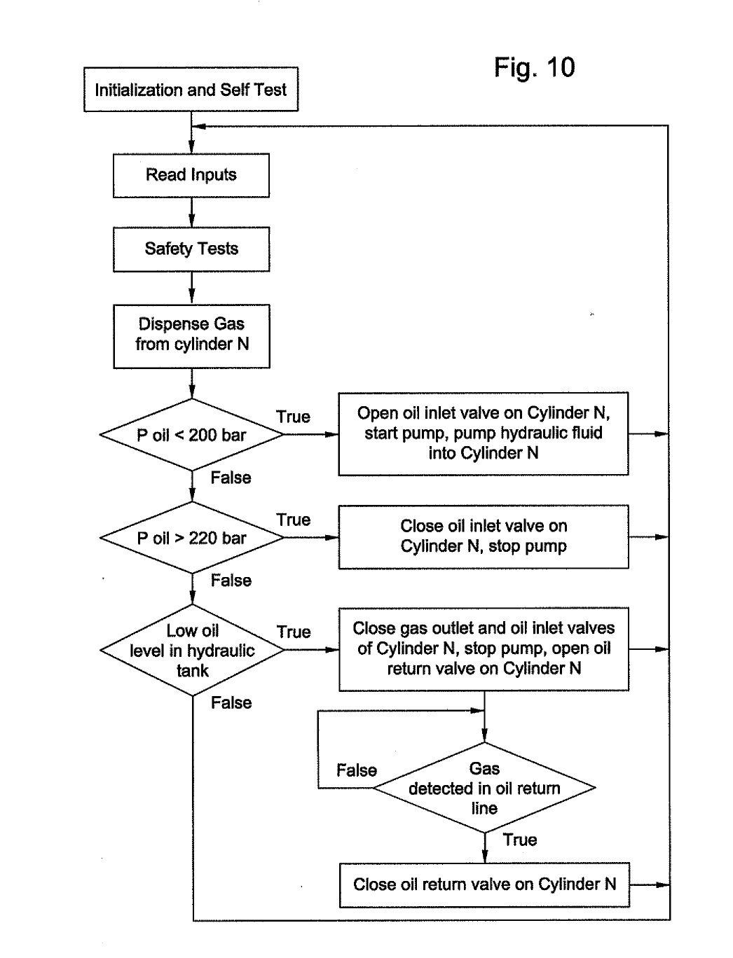

As illustrated by FIG. 10, the gas is simultaneously dispensed and the process discussed above is repeated until the hydraulic fluid volume reaches 95% of the hydraulic volume capacity of cylinder 39a of module 59 (FIG. 9). When the hydraulic fluid volume reaches 95% of the hydraulic volume capacity of cylinder 39a, level switch 7 of hydraulic fluid tank 6 sends an electronic signal to control panel (not visible), and the control panel (not visible) immediately begins unloading natural gas from cylinder 39b. If cylinder 39b is at the desired pressure, the control panel sends a signal to motor 13, which had been on, and after a short time delay switches off. However, if cylinder 39b is at a pressure less than desired, motor 13 may remain on. Simultaneously, actuated shutoff valves 35a and 42a are closed, and any excess hydraulic oil traveling to cylinder 39a is allowed to flow back to the tank 6 through excess-flow valve 3. At the same time, a signal is sent to actuated shutoff valves 36a and 17, causing them to open.

The residual 5% of the capacity of the hydraulic volume, which is high pressure gas, of cylinder 39a expands, making the hydraulic fluid that had been forced into cylinder 39a of module 59 return to tank 6, flowing through valve 36a and return line 53, hose 56, and the HPU return line 29 to actuated shutoff valve 5 and the oil reservoir tank 6, which is at atmospheric pressure.

When photoelectric sensors 63 and 64 detect gas in return line 29, the sensor sends an electrical signal to the control panel, which sends an electrical signal to actuated shutoff valves 36a and 5, which had been open and now close, thereby shutting down the return of hydraulic fluid to tank 6. In the event that sensors 63, 64, do not detect the presence of gas, a pressure sensor (not visible) within tank 6 monitors the pressure within tank 6. If the pressure in tank 6 were to rise above atmospheric, this would indicate that gas had entered tank 6, and an electric signal would be sent to actuated shutoff valves 36a and 5, closing them.

As previously noted, while the oil discharge process is occurring for cylinder 39a, compressed gas may be simultaneously unloaded from cylinder 39b (beginning another cycle). Additionally, once each cylinder in module 59 is exhausted, a second module with fully charged cylinders located on a second over-the-road semi trailer can begin unloading while the hydraulic fluid in final cylinder 39d is discharged. Once the hydraulic oil discharge process begins for cylinder 39d, hoses 57, 54 can be disconnected from module 59 and connected to the second module on the second semi trailer. Compressed gas may then be dispensed from the second module in the same manner as previously discussed, while cylinder 39d is discharging. When the hydraulic oil discharge process for cylinder 39d is complete, module 59 can be declined to its original position parallel to the ground (FIG. 2), and hose 56 may be disconnected from module 59 and connected to the second module. Module 59 may then be taken away for refilling of cylinder 39a-d. The number of cylinders in each module, and the number of modules depends solely on the volume of gas that needs to be transported and the manufacturing standards of the over-the-road semi trailer.

The invention has significant advantages. The hydraulic pressurization equipment is capable of servicing motor vehicles efficiently while maintaining the same pressure at all times. The special curved adapters, together with the inclination of the cylinder module, ensure efficient dispensing and discharging of the cylinders with minimal risk of gas entering the discharge line or hydraulic fluid entering the dispensing line. The quick connect/disconnect qualities of the hose connection between the HPU and the cylinder module allow for timely and efficient transition from one module to another.

While the invention has been shown in only a few of its forms, it should be apparent to those skilled in the art that it is not so limited but is susceptible to various changes without departing from the scope of the invention.

1. An apparatus for dispensing compressed gas, the apparatus comprising:
a transport vehicle;
at least one cylinder mounted on the vehicle for containing a quantity of compressed gas;
a gas dispensing port on a dispensing end of the at least one cylinder;
a hydraulic fluid port for flowing hydraulic fluid into the at least one cylinder as compressed gas is dispensed; and
a tilt mechanism for tilting the dispensing end of the cylinder upward relative to the vehicle to reduce outflow of hydraulic fluid out the gas dispensing port.

2. The apparatus of claim 1, further comprising:
a hydraulic fluid tank for containing the hydraulic fluid;
a pump connected between the at least one cylinder and the hydraulic fluid tank for pumping the hydraulic fluid into the at least one cylinder to maintain a constant pressure while the compressed gas is dispensed therefrom; and
a discharge line connected between the at least one cylinder and the hydraulic fluid tank such that the hydraulic fluid is discharged from the at least one cylinder and back into the hydraulic fluid tank when compressed gas in the at least one cylinder is exhausted.

3. The apparatus of claim 1, wherein the gas dispensing port comprises:
a curved tube compressed gas adapter positioned within the at least one cylinder at the dispensing end, wherein the adapter has an inner end adjacent an upper side of the at least one cylinder and an outer end located on an axis of the at least one cylinder.

4. The apparatus of claim 1, wherein the hydraulic fluid port is located on a charging end of the at least one cylinder and comprises:
a curved tube hydraulic fluid adapter positioned within the at least one cylinder at the charging end, wherein the adapter has an inner end adjacent a bottom side of the at least one cylinder and an outer end located on an axis of the at least one cylinder.

5. The apparatus of claim 1, wherein the gas discharging port comprises:
a curved tube compressed gas adapter positioned within the at least one cylinder at the dispensing end, wherein the adapter has an inner end adjacent an upper side of the at least one cylinder and an outer end located on an axis of the at least one cylinder; and
wherein the hydraulic fluid port is located on a charging end of the at least one cylinder and comprises:
a curved tube hydraulic fluid adapter positioned within the at least one cylinder at the charging end, wherein the adapter has an inner end adjacent a bottom side of the at least one cylinder and an outer end located on an axis of the at least one cylinder.

6. The apparatus of claim 1, wherein the at least one cylinder comprises a plurality of cylinders mounted on the vehicle and tiltable in unison with each other.

7. The apparatus of claim 1, wherein the vehicle comprises an over-the-road semi trailer.

8. The apparatus of claim 1, wherein the tilting mechanism comprises a hydraulic cylinder and piston.

9. An apparatus for dispensing compressed gas, the apparatus comprising:
a transport vehicle;
at least one cylinder mounted on the vehicle for containing a quantity of compressed gas, the at least one cylinder having a dispensing end with a concave inner surface and concave outer surface;
a gas dispensing port on the dispensing end of the at least one cylinder, the gas dispensing port having a curved tube compressed gas adapter positioned within the at least one cylinder at the dispensing end, wherein the adapter has an inner end adjacent an upper side of the at least one cylinder and an outer end located on an axis of the at least one cylinder; and
a hydraulic fluid port for flowing hydraulic fluid into the at least one cylinder as compressed gas is dispensed.

10. The apparatus of claim 9, wherein the hydraulic fluid port is located on a charging end of the at least one cylinder, and comprises:
a curved tube hydraulic fluid adapter positioned within the at least one cylinder at the charging end, wherein the adapter has an inner end adjacent a bottom side of the at least one cylinder and an outer end located on an axis of the at least one cylinder.

11. The apparatus of claim 9, further comprising:
a tilt mechanism for tilting the dispensing end of the cylinder upward relative to the vehicle to reduce outflow of hydraulic fluid out the gas dispensing port.

12. The apparatus of claim 11, wherein the tilting mechanism comprises a hydraulic cylinder and piston.

13. The apparatus of claim 9, further comprising:
a hydraulic fluid tank for containing the hydraulic fluid;
a pump connected between the at least one cylinder and the hydraulic fluid tank for pumping the hydraulic fluid into the at least one cylinder to maintain a constant pressure while the compressed gas is dispensed therefrom; and
a discharge line connected between the at least one cylinder and the hydraulic fluid tank such that the hydraulic fluid is discharged from the at least one cylinder and back into the hydraulic fluid tank when compressed gas in the at least one cylinder is exhausted.

14. The apparatus of claim 9, wherein the at least one cylinder comprises as plurality of cylinders mounted on the vehicle and tiltable in unison with each other.

15. The apparatus of claim 9, wherein the vehicle comprises an over-the-road semi trailer.

16. A method of dispensing compressed natural gas, the method comprising:
(a) mounting at least one compressed gas cylinder on a transport vehicle, the at least one cylinder having a dispensing end;
(b) filling the at least one cylinder with compressed gas and moving the transport vehicle to a compressed gas dispensing site;
(c) tilting the dispensing end of the at least one cylinder relative to the vehicle;
(d) dispensing compressed gas from the dispensing end of the at least one cylinder; and
(e) pumping hydraulic fluid into the at least one cylinder to maintain a constant pressure therein as the compressed gas is dispensed.

17. The method of claim 16, wherein step (e) comprises pumping the hydraulic fluid into a charging end opposite the dispensing end.

18. The method of claim 17, further comprising after substantially all of the compressed gas is dispensed, discharging the hydraulic fluid from the charging end of the at least one cylinder.
